(19) United States
(12) Patent Application Publication
(10) Pub. No.: US 2026/0328051 A1
(43) Pub. Date: Oct. 22, 2026

(54) MAGNETIC FINGER PINCH PROTECTION DEVICE AND METHODS OF USE

(71) Applicant: Peter Pavlow, Sparta, NJ (US)

(72) Inventor: Peter Pavlow, Sparta, NJ (US)

(21) Appl. No.: 19/529,345

(22) Filed: Feb. 4, 2026

Related U.S. Application Data
(60) Provisional application No. 63/764,751, filed on Feb. 28, 2025.

(51) Int. Cl. E06B 7/36

(52) U.S. Cl. CPC E06B 7/362

(57) ABSTRACT

A magnetic finger pinch protection device and methods of use are disclosed. The device includes a body configured to magnetically engage a ferromagnetic hinge component of a door and to establish a controlled interference geometry that inhibits full door closure. When engaged, the device maintains a minimum spacing between the door and the door frame, thereby reducing finger-pinch hazards. The device permits tool-free installation and removal without adhesive-based operative attachment and may include a ferromagnetic storage element for retention when not in use.

### CROSS-REFERENCE TO RELATED APPLICATIONS

This application claims the benefit of and priority to U.S. Provisional Patent Application No. 63/764,751, filed Feb. 28, 2025, entitled “MAGNETIC FINGER PINCH PROTECTOR,” the entire disclosure of which is hereby expressly incorporated by reference in its entirety for all purposes. Any inconsistencies between this application and the incorporated provisional application shall be resolved in favor of this application to the extent permitted by law.

### STATEMENT REGARDING FEDERALLY SPONSORED RESEARCH OR DEVELOPMENT

The invention described herein was not made under any federally sponsored research or development program, and no governmental rights are claimed or implied in connection with the present invention.

### FIELD OF THE INVENTION

The present invention relates generally to safety and injury-prevention devices. More specifically, the invention relates to devices, systems, and methods for preventing finger, hand, and soft-tissue injuries caused by the closing movement of doors.

The invention is particularly directed to magnetically attachable, hinge-adjacent safety devices configured to mechanically inhibit full door closure by establishing a controlled interference geometry between a door and a door frame, thereby reducing or eliminating finger-pinch hazards. The invention is especially suitable for protecting children, pets, elderly individuals, and other vulnerable users in residential, commercial, educational, healthcare, and institutional environments.

### BACKGROUND OF THE INVENTION

Finger-pinch injuries caused by closing doors represent a persistent safety concern across residential and institutional settings. Such injuries frequently occur at the hinge side of doors, where the converging geometry between the door and the door frame creates severe pinch points capable of causing fractures, soft-tissue injuries, or amputations. These risks are heightened in environments where doors are frequently opened and closed and where children or other vulnerable individuals are present.

Existing safety solutions intended to address door-related injuries include foam wedges, adhesive spacers, floor-mounted stops, wall-mounted stops, and hinge guards. While these solutions may reduce certain risks, many suffer from limitations including unreliable retention, adhesive degradation, surface damage, aesthetic intrusion, permanent installation requirements, and incompatibility with common door configurations. Moreover, many known devices fail to address hinge-side pinch geometry directly or cannot be conveniently repositioned or removed when full door closure is desired.

Accordingly, there remains a need for a compact, non-invasive, reusable safety device that can be securely retained at the hinge side of a door, that does not rely on adhesive-based attachment for operative placement, and that mechanically controls door movement by establishing a defined spacing between the door and the door frame. There is further a need for such a device to be easily installed and removed without tools, to remain reliably positioned during normal use, and to provide consistent finger-pinch protection across a wide range of door types.

### SUMMARY OF THE INVENTION

The present invention provides a magnetic finger pinch protection device and related methods of use for reducing finger and hand injuries caused by the closing movement of doors and other hinged panels. The device is configured to magnetically engage a ferromagnetic hinge component of a door assembly and to mechanically inhibit full closure of the door by establishing a controlled interference geometry between the door and the door frame.

In one aspect, the invention comprises a body formed from a durable, non-toxic material and incorporating at least one magnet configured to releasably secure the body to a ferromagnetic hinge leaf, hinge plate, or hinge fastener of a door. When magnetically engaged, the body occupies a hinge-adjacent position that maintains the door in a partially open state, thereby reducing or eliminating pinch points on both the hinge side and the latch side of the door.

In another aspect, the body is dimensioned and contoured to define a predetermined spacing between the door and the door frame when engaged, such that further closing movement of the door is mechanically resisted at a controlled distance. This controlled spacing prevents the formation of finger-pinch geometry while allowing limited door movement.

In certain embodiments, the body includes resilient contact surfaces positioned at load-bearing regions of the device. These surfaces are configured to absorb impact forces, reduce noise, and minimize damage to the door or door frame during repeated use.

The magnetic attachment enables tool-free installation and removal without adhesives, screws, or permanent fasteners for operative placement. The device may further include a ferromagnetic storage element configured to magnetically retain the device on or near the door when not in use. The invention thereby provides a reusable, magnet-based, hinge-specific solution for preventing door-related finger-pinch injuries.

### BRIEF DESCRIPTION OF THE DRAWINGS

FIG. 1 is a perspective view of a magnetic finger pinch protection device and a ferromagnetic storage element.

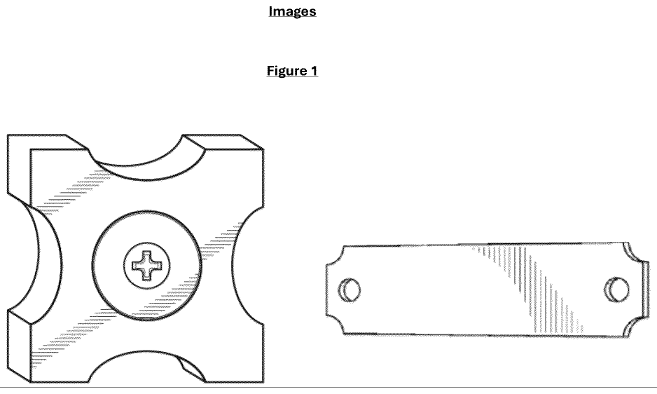

FIG. 2 is a rear perspective view illustrating one or more magnets embedded within the body of the device.

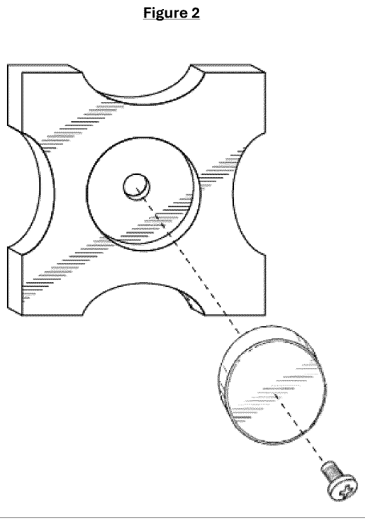

FIG. 3 is a detailed view showing magnetic engagement between the device and a ferromagnetic hinge component.

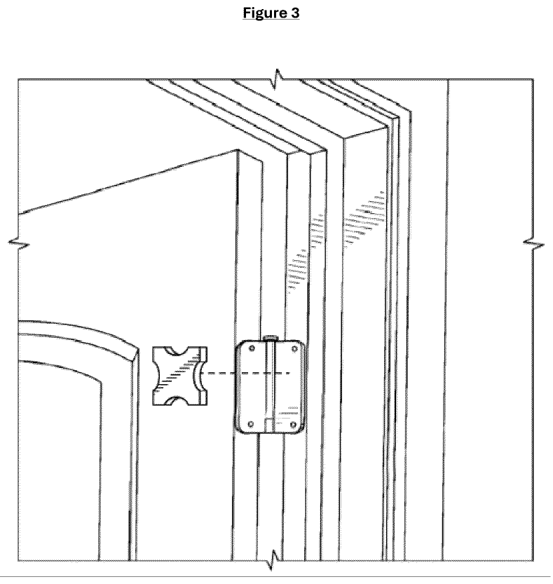

FIG. 4 is a perspective view of the device positioned adjacent a door hinge and defining a controlled interference geometry.

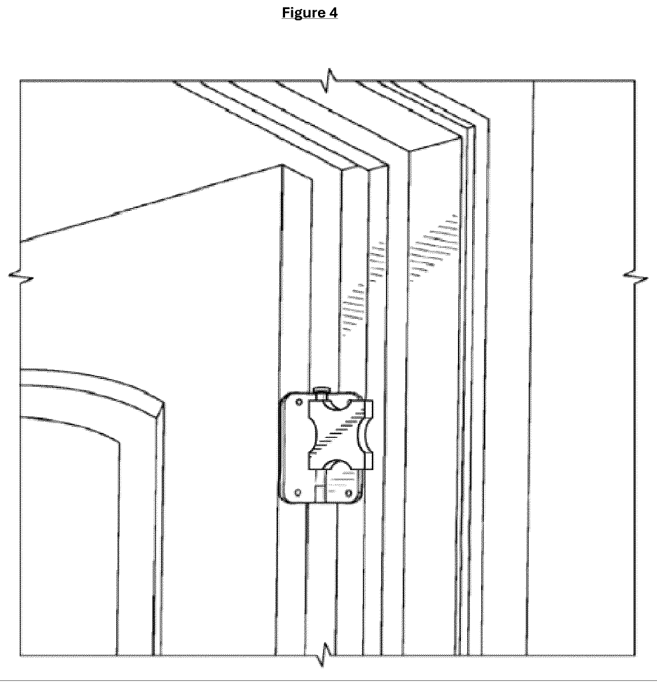

FIG. 5 is a view illustrating alignment of the device with the ferromagnetic storage element.

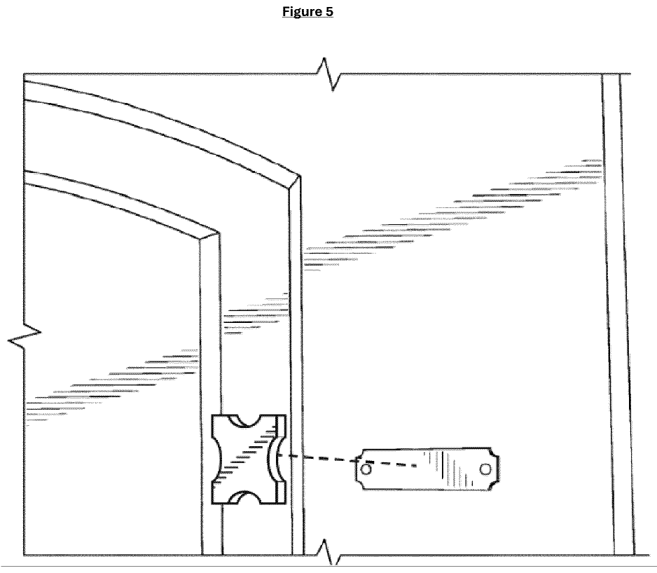

FIG. 6 is a view showing the device magnetically retained on the storage element when not in use.

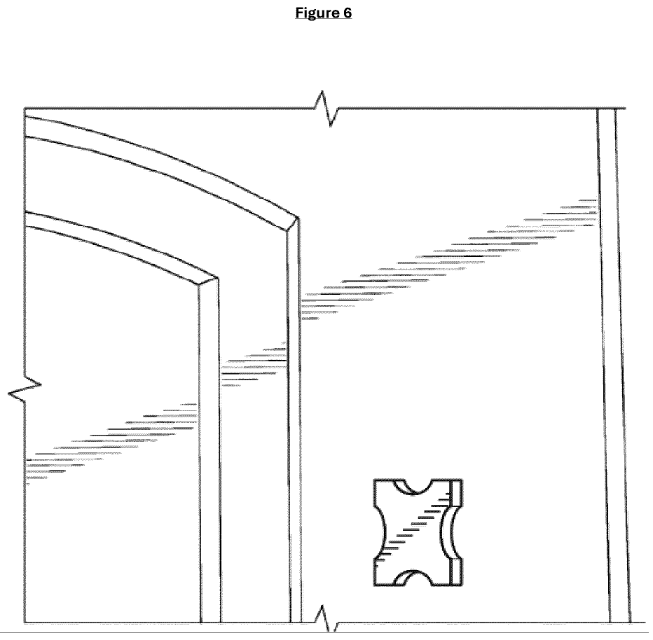

### DETAILED DESCRIPTION OF THE INVENTION

The present invention will now be described with reference to exemplary embodiments. The description is provided to enable a person of ordinary skill in the art to make and use the invention, it being understood that variations and modifications may be made without departing from the scope of the invention as defined by the claims.

The magnetic finger pinch protection device comprises a body configured to be positioned adjacent a door hinge and to magnetically engage a ferromagnetic hinge component, such as a hinge leaf, hinge plate, or hinge fastener. The body may be formed from polymeric, elastomeric, or composite materials selected to provide structural integrity and impact resistance.

One or more magnets are embedded within or secured to the body and oriented to provide reliable magnetic retention during normal door movement while permitting intentional manual removal without tools. When magnetically engaged, the body is positioned between the door and the door frame such that the door is prevented from fully closing.

In the engaged position, the body establishes a predetermined interference geometry that defines a minimum spacing between the door and the door frame. The controlled spacing is selected to prevent formation of finger-pinch geometry between the door and the door frame during closing movement.

In certain embodiments, the body includes resilient contact surfaces positioned at load-bearing regions that contact the door or door frame during closing movement. These surfaces absorb impact forces, reduce noise, and protect door surfaces.

The device may further include a ferromagnetic storage element mounted on or near the door or door frame. When the device is not engaged with the hinge, it may be magnetically retained on the storage element for convenient access.

Methods of use include magnetically securing the device to a ferromagnetic hinge component prior to door closure, allowing limited door movement while inhibiting full closure, and magnetically disengaging and storing the device when full closure is desired.

1. A finger pinch protection device for a door, comprising:
a body sized and shaped to be positioned adjacent a door hinge; and
at least one magnet coupled to the body and configured to magnetically engage a ferromagnetic hinge leaf, hinge plate, or hinge fastener of the door,
wherein, when magnetically engaged, the body establishes a controlled interference geometry defining a minimum spacing between the door and the door frame sufficient to prevent formation of a finger-pinch condition.

2. The device of claim 1, wherein the body is configured to maintain a minimum spacing between the door and the door frame.

3. The device of claim 1, wherein the magnet is embedded within the body.

4. The device of claim 1, wherein the magnet provides sufficient holding force to remain engaged during normal opening and closing while permitting manual removal without tools.

5. The device of claim 1, wherein the body includes a resilient contact surface positioned at a load-bearing region.

6. The device of claim 5, wherein the resilient contact surface comprises a rubberized edge.

7. The device of claim 1, wherein the device is installed for operative placement without adhesives, screws, or mechanical fasteners.

8. The device of claim 1, further comprising a ferromagnetic storage element configured to magnetically retain the device when not engaged with the hinge.

9. A method of reducing finger-pinch injuries caused by a door, comprising:
magnetically securing a device according to claim 1 to a ferromagnetic hinge component;
allowing limited door movement while inhibiting full closure; and
maintaining a controlled spacing between the door and the door frame.
